(19) United States
(12) Patent Application Publication
(10) Pub. No.: US 2025/0170733 A1
(43) Pub. Date: May 29, 2025

(54) Separately Tensionable Scissors

(71) Applicant: Chao Wei, Irvine, CA (US)

(72) Inventor: Chao Wei, Irvine, CA (US)

(21) Appl. No.: 18/521,084

(22) Filed: Nov. 28, 2023

(51) Int. Cl. B26B 13/28

(52) U.S. Cl. CPC B26B 13/285

(57) ABSTRACT

A pair of hair cutting or pet scissors that have two blades operationally connected by a dual taper, dual threaded bolt and a nut for adjustment and a nut for assembly. The assembly allows for the scissor blades to be brought into tighter or looser frictional contact with each other without being disassembled. There is a tool that engages the bolt to rotate either of the nuts separately for adjusting the feel of the blades or for disassembly and repair or sharpening.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to hand scissors used for cutting hair or fur, and more particularly to a nut and bolt assembly that allows a scissor blade adjustment without unlocking and disassembling the scissors.

### BACKGROUND

All prior art professional hairdressing and pet shearing scissors have a common design wherein the two blades pivot about a connecting member positioned through the center of an orifice formed along the linear axis of each blade. The friction to open and close the blades, or the “cutting feel of the blades” is adjusted by adjusting the proximity of the blades relative to each other. Thus, to adjust the proximity of the blades together, the connecting member must be loosened or tightened. The problem with this is that if the blades are loosened enough, the connecting member will separate and the blades will separate. Simply stated, the function of connecting the scissor blades together cannot be separated from the function of adjusting the cutting feel of the scissor blades.

A pair of cutting scissors that allowed for a looseness or cutting feel adjustment, separate from the function of disassembling the scissor blades for sharpening, would allow haircutters to adjust their scissors but only a repair and sharpening professionals to take the scissors apart.

Thus, a solution is provided by the embodiments set forth below.

Henceforth, a pair of scissors that may be locked together by a connecting member and separately adjusted for feel by the same locking member would fulfill a long felt need in the hairdressing industry. This new invention utilizes and combines known and new technologies in a unique and novel configuration to overcome the aforementioned problems and accomplish this.

### BRIEF SUMMARY

In accordance with various embodiments, a pair of hairdressing or pet shearing scissors with separate adjustment and blade fixing capabilities is provided.

In one aspect, a pair of scissors with a dual function blade connecting member that uses a first end of a tool to adjust the tightness of the two blades, and a second end of the same tool to disassemble the scissors.

In another aspect, a connecting member (a nut and bolt assembly) with a stepped shaft bolt, bearing both a right thread (clockwise to tighten) and a left thread (clockwise to tighten), a collar nut, a locking nut and a locking washer.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is an exploded view of the connecting member of prior art scissors;

FIG. 2 is a cross sectional view of the connecting member in an assembled pair of scissors;

FIG. 3 is a side view of a locking nut;

FIG. 4 is a bottom view of a locking nut;

FIG. 5 is a side view of the blade bearing;

FIG. 6 is a top view of a blade bearing;

FIG. 7 is a side view of a tensioning nut;

FIG. 8 is a top view of a tensioning nut;

FIG. 9 is a side view of a dual stepped, dual threaded bolt;

FIG. 10 is a top view of a dual stepped, dual threaded bolt;

FIG. 11 is a side view of a washer;

FIG. 12 is a top view of a washer;

FIG. 13 is an exploded side view of the connecting member;

FIG. 14 is a top view of the assembled connecting member;

FIG. 15 is a bottom view of the assembled connecting member;

FIG. 16 is a top view of the assembled tensionable scissors;

FIG. 17 is a cross sectional view of the connecting member in the tensionable scissors;

FIG. 18 is a side view of the tensionable tool;

FIG. 19 is an end view of the disassembly end of the tensionable tool;

FIG. 20 is an end view of the tensioning end of the tensionable tool;

FIG. 21 is a top view of the scissors finger blade; and

FIG. 22 is a top view of the scissors thumb blade.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first thread could be termed a second thread, and, similarly, a second thread could be termed a first thread, without departing from the scope of the inventive concept.

It will be understood that when an element is referred to as being “on,” “coupled to,” or “connected to” another element, it can be directly on, directly coupled to or directly connected to the other element, or intervening elements may be present. In contrast, when an element is referred to as being “directly on,” “directly coupled to,” or “directly connected to” another element, there are no intervening elements present. Like numbers refer to like elements throughout. As used herein, the term “and/or” includes any and all combinations of one or more of the associated listed items. Unless otherwise indicated, all numbers herein used to express quantities, dimensions, and so forth, should be understood as being modified in all instances by the term “about.” In this application, the use of the singular includes the plural unless specifically stated otherwise.

In the following description, for the purposes of explanation, numerous specific details are set forth in order to provide a thorough understanding of the described embodiments. It will be apparent to one skilled in the art, however, that other embodiments of the present invention may be practiced without some of these specific details. It should be appreciated that the features described with respect to one embodiment may be incorporated with other embodiments as well. By the same token, however, no single feature or features of any described embodiment should be considered essential to every embodiment of the invention, as other embodiments of the invention may omit such features.

As used herein, the term “right hand thread” refers to a thread that when turned clockwise tightens the internally and externally threaded members together.

As used herein, the term “left hand thread” refers to a thread that when turned counter-clockwise tightens the internally and externally threaded members together.

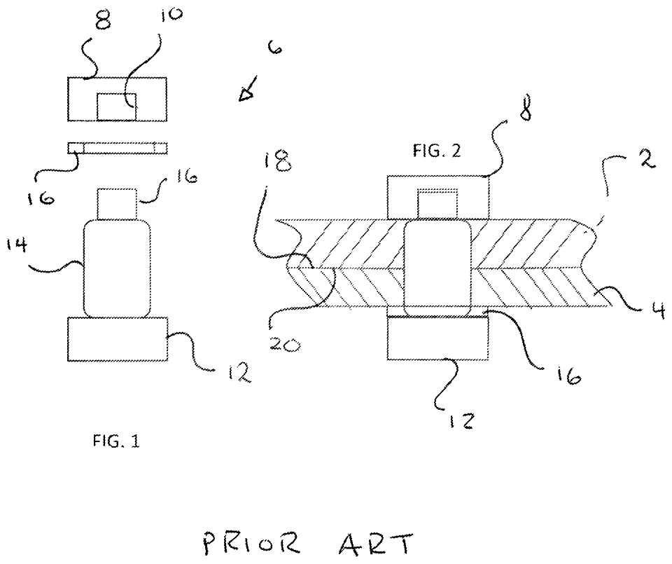

Looking at FIGS. 1 and 2, a pair of prior art scissors are best seen and explained. Scissors have a scissors first blade (thumb or bottom blade) 2 and a scissors second (finger or top blade) 4 that each have a sharpened (cutting) edge and an orifice formed therethrough between the distal and proximal ends of each blade. Through these orifices is a connecting fastener 6 comprised of a nut 8 with an internally threaded bore 10, a bolt 12 having a circular shoulder 14 and an externally threaded end 16 that is threadingly engageable with the threaded bore 10. There is an optional washer 16 that may be placed on the connecting fastener 6, in contact with the first blade 2 or the second blade 4. When the two blades 2 and 4 are positioned together so that their orifices align, the connecting fastener 6 may be placed therethrough and the nut 8 tightened onto the bolt 12 so as to draw the cutting faces 18 and 20 into frictional engagement. To increase the tension to open and close the scissors, the connecting fastener 6 is just tightened. To decrease the scissor tension, or to disassemble the scissors, the connecting fastener 6 is loosened. Therein lies the problem. The more the connecting fastener 6 is loosened, the closer the two blades of the scissors come to disengaging. This is so because the threaded portion of the connecting fastener 6 has few thread turns because of its short length size.

The present invention relates to a novel design for a pair of hairdressing or animal hair/fur cutting scissors that utilize a tool to disassemble the scissors and a tool to adjust the tightness of the scissors. This allows the tightness/looseness or what is referred to as the “feel of the scissors” to be adjusted separately from loosening the connecting member that holds the blades of the scissors together.

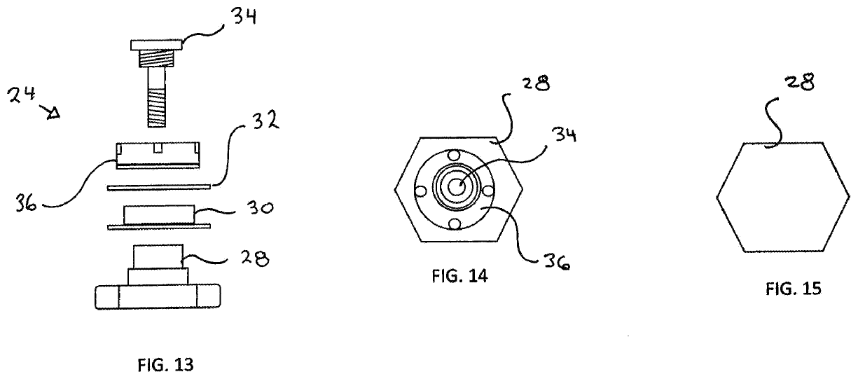

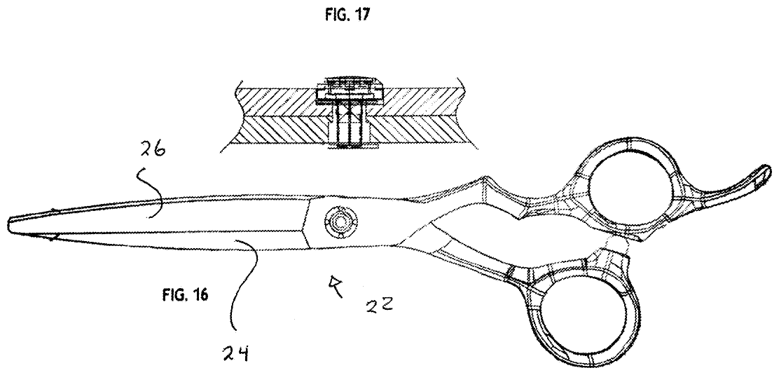

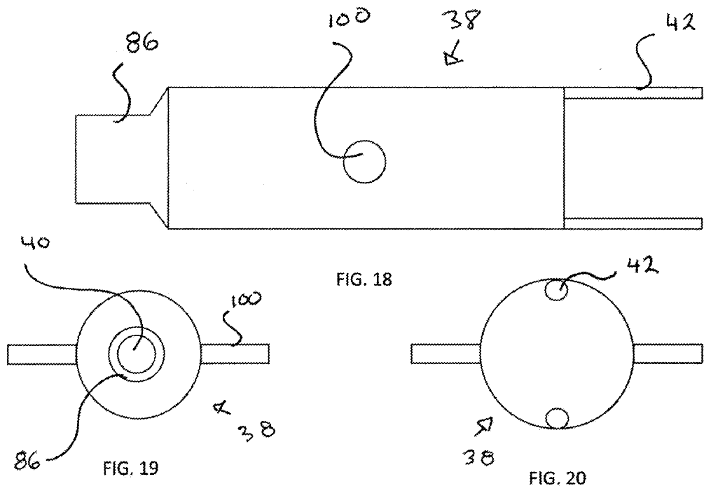

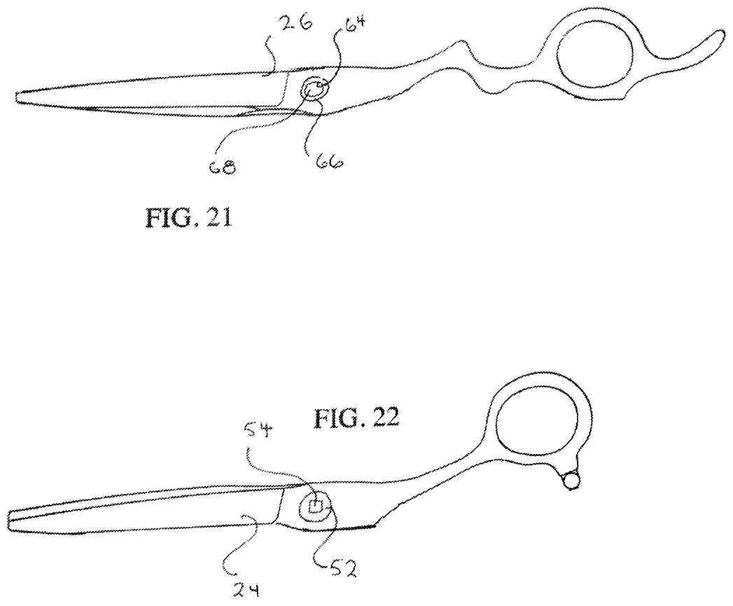

With reference to FIGS. 13, 16, 2, 22 and 18-20 the separately tensionable scissors 22, its connecting member 24 and tool 38, can best be seen. The tensionable scissors 22 (FIG. 13) have the following eight components including its tool: a first blade 24, a second blade 26, a locking nut 28, a blade bearing 30, a washer 32 (optional), a dual stepped, dual threaded disassembly bolt 34, and threaded tension nut 36. The dual purpose tool 38 has a disassembly recess 40 at its distal end, and a tensioning fitting 42 at its proximal end.

The separately tensionable scissors 22 herein is discussed with the stepped nut extending from the outer face of the second (finger) blade 26 and the locking nut 28 extending from the outer face in contact with the first (thumb) blade 24, however it is known that this configuration may be reversed.

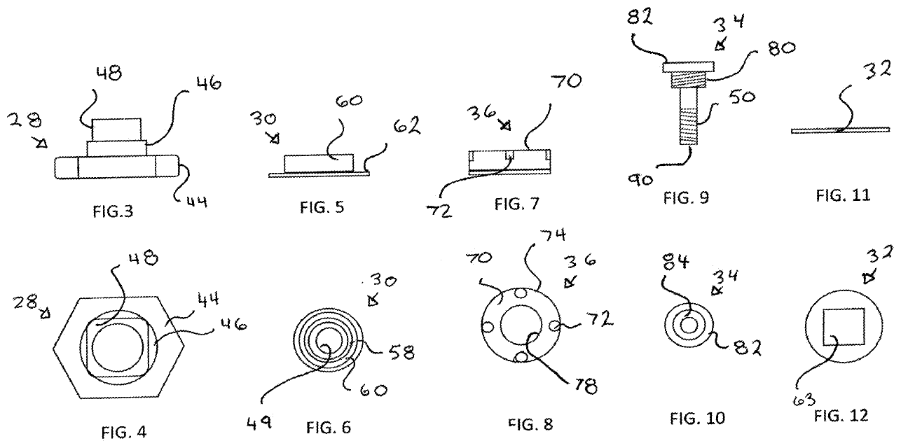

FIGS. 3-12 and 18-20 describing the eight components of the separately tensionable scissors in detail. Looking at FIGS. 3 and 4 it can be seen that the locking nut 28 has three steps. The first step 44 is a hexagonal flange that abuts the outer face of the thumb blade 24, while the second step 46 forms a circular flange that frictionally engages the inner race 49 of the blade bearing 30. The third step 48 is an internally right hand threaded square post. It threadingly engages with the right handed disengagement thread 50 on the distal end of the dual stepped, dual threaded bolt 34 when the scissor blades 24 and 26 are assembled to make an operable pair of scissors. Looking at FIG. 22 shows that there is a circular concave recess 52 formed on the outer face of the thumb blade 24 with a square orifice 54 formed through the approximate center of the recess 52. When the blade bearing 30 is placed onto the circular flange 46 the locking nut 28 may be inserted into the thumb blade 24 with the blade bearing 30 in frictional contact with the recess 52, and the square post 48 in contact with and passing through the square orifice 54.

As can be seen in FIGS. 5 and 6, the blade bearing 30 is a circular bearing with an inner race 49, a separator cage 58 and an outer race 60 with a circular flange 62 extending from the perimeter of the lower peripheral edge of the outer race 60. It serves to minimize any resistance encountered in rotating the thumb blade 24 about the dual stepped, dual threaded bolt 34.

FIGS. 11 and 12, and 7 and 8 illustrate that the washer 32, is a planar disk with a square orifice 63 formed therethrough its center. It sits on the inner flange 64 of the concave recess 66 formed on the top face of the finger blade 26 and around the square post 48 of the locking nut 28 once it passes into the centered orifice 68 formed through the concave recess 66 of the finger blade 26.

FIGS. 7 and 8 show that the tension nut 36 is a nut with a circular peripheral configuration and a top face 70 with a set of four equally spaced engagement bores 72 formed thereon the peripheral edge 74 and a central. These bores 72 engage the prongs 42 of the tool 38 for rotational adjustment of the tension nut 36 by its handle 100, about the dual stepped, dual threaded disassembly bolt 34. This tension nut 36 is internally threaded 78 in a left hand thread (counter clockwise to tighten) for mating engagement with the left hand tensioning thread 80 on the threaded bolt 34. When the tension nut 36 is threaded onto the disassembly threaded bolt 34 it will reside in the concave recess 66 of the finger blade 26, in contact with the washer 32.

The disassembly bolt 34 has a circular head 82 with a centered circular groove 84 formed partially therein. This groove is frictionally engageable by the hollow, tubular, circular stub 86 on one end of the tool 38 for rotation of the right handed disengagement thread 50 on the distal end of the disassembly bolt 34. The shaft 90 of the disassembly bolt 34 has two steps in diameter. The lower (smaller dimeter) step bears a right hand thread thereon 50, and the upper (larger diameter) step bears a left hand thread thereon. When the scissors are assembled the right hand thread engages the right hand thread in the locking nut 28 and the left hand thread engages the left hand thread in the tension nut 36.

The connecting means 24 is assembled in the order shown in the exploded side view of FIG. 13 with the thumb blade 24 in contact with the blade bearing 30 and its flange 62, and the finger blade 26 in contact with the washer 32 and the tension bolt 36. The inner faces of the two blades are in contact with each other along their cutting faces. It is this tight close frictional contact between these two blades that facilitates the cutting of hair. If this frictional contact it too great, the scissors will dull quicker, cause hand fatigue and have a very stiff feel. If the frictional contact is too sloppy, the scissors will wobble, feel too easy to manipulate, cut poorly and be prone to unexpected disassembly.

In operation, the first and second blades 24 and 26 are positioned such that their cutting (inner) faces are in contact and their orifices 54 and 64 are aligned. The connecting member 24 is inserted through both of the aligned orifices such that the blade bearing 30 residing on the locking nut 28 sits in the recess 52 of the first blade 24 with the square post 48 passing through and extending slightly beyond the square orifice 54 so as to extend into the orifice 68 centered in the recess 66 of the second blade 26. The tension nut 36 is threaded partway onto the left hand tensioning thread 80 of the disassembly bolt 34 which is threaded into the right hand thread of the square post 48 as it is placed into the recess 66 so as to sit on the washer 32. The disassembly recess 40 of the dual purpose tool 38 is inserted into the circular groove 84 of the disassembly bolt 34 and tightened clockwise to draw the blades together to the approximate frictional resistance the user wants. The scissors are now operational. To adjust the feel of the blades either tighter or looser, the tensioning prong 42 of the tool 38 are inserted into the bores 72 of the tension nut 34 and the tension nut 34 is rotated counterclockwise to loosen or clockwise to tighten.

In simplistic terms, the lower, right handed thread on the disassembly bolt 34 when tightened into the locking nut 28, affixes the blades together by pushing the finger blade 6 in close frictional engagement with the thumb blade 24. The tension nut 34 is what contacts the upper blade 26 and forces it into engagement with the lower blade. So once the upper blade 26 is sufficiently tightened with the disassembly bolt, although the disassembly bolt 34 and the locking nut 28 hold the scissors together the intermediary tension nut 34 acts to increase or decrease this force. Since the nuts are threaded in different directions they can function independently to either adjust the blade opening and closing force or to disassemble the scissors.

While certain features and aspects have been described with respect to exemplary embodiments, one skilled in the art will recognize that numerous modifications are possible. Consequently, in view of the wide variety of permutations to the embodiments described herein, this detailed description and accompanying material is intended to be illustrative only, and should not be taken as limiting the scope of the inventive concept. What is claimed as the invention, therefore, is all such modifications as may come within the scope and spirit of the following claims and equivalents thereto.

1. A pair of scissors, capable of separate blade tensioning and blade disassembly, comprising:
a first scissors blade having an first inner face and a first outer face with a concave first recess formed thereon, said first recess having a first orifice formed therethrough;
a second scissors blade having an second inner face and a second outer face with a concave second recess formed thereon, said second recess having a second orifice formed therethrough;
a locking nut having an internally threaded post extending therefrom;
an internally threaded tension nut;
a disassembly bolt having a shaft with an exterior upper thread and an exterior lower thread formed thereon, wherein one of said upper thread and said lower thread is a left hand thread and one is of a right hand thread; and
wherein said first inner face and said second inner face are in contact and said first orifice and said second orifice in alignment, and said locking nut resides in said first recess with said threaded post extending through said first orifice; and
wherein said tension nut is threadingly engaged on said upper exterior thread, and said disassembly bolt resides in said second recess with said shaft passing through said second orifice, and said lower exterior thread threadingly engaged with said post of said locking nut.

2. The pair of scissors of claim 1 further comprising:
a blade bearing, said blade bearing affixed on said locking nut and in contact with said first recess.

3. The pair of scissors of claim 1 further comprising:
at least two detents in a top face of said tension nut; and
a tool having a proximal end and a distal end, with a pair of prongs extending from said proximal end, said prongs sized and configured geometrically for mating engagement with said two detents.

4. The pair of scissors of claim 1 further comprising:
a centered circular groove formed partially therein a head of said disassembly bolt; and
a tool having a distal end with a circular socked formed thereon, said socket conformed for frictional engagement with said circular groove.

5. The pair of scissors of claim 3 further comprising:
a centered circular groove formed partially therein a head of said disassembly bolt; and
a circular socked formed on a distal end of said tool, said socket conformed for frictional engagement with said circular groove.

6. The pair of scissors of claim 2 further comprising;
a washer placed in said second recess between a bottom of said second recess and said tensioning nut.

7. A pair of scissors, capable of separate blade tensioning and blade disassembly, comprising:
a first scissors blade having an first inner face and a first outer face with a concave first recess formed thereon, said first recess having a square orifice formed therethrough;
a second scissors blade having an second inner face and a second outer face with a concave second recess formed thereon, said second recess having a round orifice formed therethrough;
a locking nut having a right hand, internally threaded square post extending therefrom and a blade bearing residing thereon said locking nut, said blade bearing in contact with said first recess;
a left hand internally threaded tension nut;
a washer placed in said second recess between a bottom of said second recess and said tensioning nut;
a disassembly bolt having a shaft with an exterior left hand upper thread and an exterior right hand lower thread formed thereon; and
wherein said first inner face and said second inner face are in contact and said first orifice and said second orifice are in alignment, and said locking nut resides in said first recess with said threaded post extending through said first orifice; and
wherein said tension nut is threadingly engaged on said upper exterior thread, and said disassembly bolt resides in said second recess atop said washer, with said shaft passing through said second orifice, and said lower exterior thread threadingly engaged with said internal threads of said square post of said locking nut.
